(19) United States
(12) Patent Application Publication
(10) Pub. No.: US 2005/0184174 A1
(43) Pub. Date: Aug. 25, 2005

(54) Modular spreader system

(75) Inventors: George Bailey, Byron, IL (US); Shane Tipton, Lindenwood, IL (US)

Correspondence Address: BROUSE MCDOWELL, 388 SOUTH MAIN STREET, SUITE 500, AKRON, OH, 44311-4407, US

(73) Assignee: SWENSON SPREADER COMPANY

(21) Appl. No.: 11/046,106

(22) Filed: Jan. 28, 2005

Related U.S. Application Data
(60) Provisional application No. 60/539,806, filed on Jan. 28, 2004.
(60) Provisional application No. 60/627,407, filed on Nov. 12, 2004.

(51) Int. Cl. A01C 3/06

(52) U.S. Cl. 239/672; 239/668; 239/681; 239/677

(57) ABSTRACT

A modular spreader system is provided. The spreader may include a conveyor system defining a frame, a hopper and, a method of attaching the hopper to the frame and for detaching the hopper from the frame. A hydraulic unit may be provided to provide power to the conveyor belt. The hydraulic unit may easily be replaced with an engine. The spreader system may also have a spinner system that can be easily swung out of the way so that the spreader material can be emptied without need to be processed through the spinner system.

This application claims priority to U.S. Ser. No. 60/539,806, entitled SPREADER WITH POLYETHELENE HOPPER, filed Jan. 28, 2004, and U.S. Ser. No. 60/627,407, entitled PLASTIC PV HOPPER II, filed Nov. 12, 2004, both of which are incorporated herein by reference.

### I. BACKGROUND OF THE INVENTION

A. Field of Invention

This invention pertains to the art of methods and apparatuses for spreader systems, and more specifically to a modular spreader system where the hopper and/or power system can easily be replaced.

B. Description of the Related Art

During harsh winter months, snow and ice accumulates on roads, driveways, parking lots and other such surfaces. When heavy snow and/or ice accumulate, these surfaces are often treated by scraping away the snow with a snow plow and then treating the surface with salt, sand or other material to provide traction and eliminate slippery conditions for motorists. A spreader system is typically used to spread salt or sand. Spreader systems known in the art, while suited for their intended purpose, still have disadvantages. First, most spreader systems are made of steel, which is heavy, and not always corrosion resistant. Second, the accompanying spinner system is generally stationary, such that when an operator is finished treating roadways, any remaining salt or sand must be evacuated through the spinner system. Third, no known spreader system in the art is a modular system such that individual components, such as the hopper or the power means, can be replaced for any reason such as in the event damage occurs.

The present invention provides a modular, polyethylene hopper which is lightweight and corrosion resistant and that may be used in conjunction with a stainless steel conveyor system. The present invention also includes a new and improved pivotal spinner system, such that the spinner system may be pivoted so that unused material can be dumped from the truck bed in an efficient manner. The inventive spreader system may be constructed from a stainless steel or other non-corrosive material.

### II. SUMMARY OF THE INVENTION

According to one aspect of the present invention, a spreader system includes a conveyor system defining a frame, a hopper and, attaching means for selectively attaching the hopper to the frame and for selectively detaching the hopper from the frame. Thus, the hopper is modular.

According to another aspect of the present invention, the hopper is made of polyethylene, such that the hopper is lightweight, durable, and corrosion resistant.

According to yet another aspect of the present invention, the conveyor can be powered either by a hydraulic unit or by an engine. In addition, at least two hydraulic options and at least two engine options may be provided. Thus, the power means is also modular.

Still yet, another objective of the present invention is to provide a spreader system that comes preassembled for the operator.

Further, another objective of the present invention is to provide a spreader system having a pivotal spinner system to enable unused material to be easily removed from the spreader system.

Further yet, another objective of the present invention is to provide a spreader system constructed from a non-corrosive material such as stainless steel.

It is yet another objective of the present invention to provide a spreader system having a conveyor trough to enclose a conveyor system.

Another objective of the present invention is to provide a spreader system that is economical to manufacture.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is an assembly side view of one embodiment of the present invention.

FIG. 2 is an assembly side view of another embodiment of the present invention.

FIG. 3 is a partial assembly back view of the embodiment shown in FIG. 2.

FIG. 4 is a top view of the hopper.

FIG. 5 is a side view of the hopper shown in FIG. 4.

FIG. 6 is a front view of the hopper shown in FIG. 4.

FIG. 7 is an enlarged view of Detail A shown in FIG. 6.

FIG. 8 is a partial assembly side view of another embodiment of the present invention showing how the modular power means attaches to the hopper and how the spinner system attaches to the modular power means.

FIG. 9 is a partial assembly front view of the embodiment shown in FIG. 8.

FIG. 10 is a partial assembly back view of the embodiment shown in FIG. 8.

FIG. 11 is a side view of the embodiment shown in FIG. 8 showing the modular power means, the hopper, and the spinner system attached together and showing the spinner system in a standard operating (down) position.

FIG. 12 is a front view of the embodiment shown in FIG. 11.

FIG. 13 is back view of the embodiment shown in FIG. 11.

FIG. 14 is a side view similar to that shown in FIG. 111 except that here the spinner system is in a dump (up) position.

FIG. 15 is back view of the embodiment shown in FIG. 14.

FIG. 16 illustrates the steps in adjusting the spinner system from the dump (up) position to the standard operating (down) position.

### IV. DESCRIPTION OF THE PREFERRED EMBODIMENT

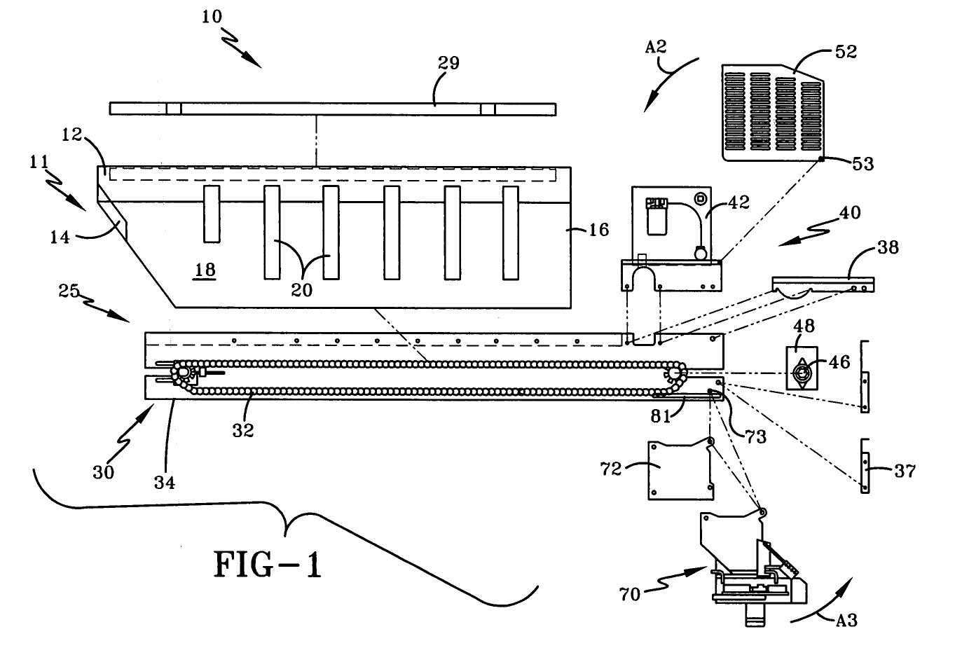

Referring now to the drawings wherein the showings are for purposes of illustrating a preferred embodiment of the invention only and not for purposes of limiting the same, FIG. 1 shows a spreader system 10 having a conveyor system 30 and incorporating a modular hopper 12 according to this invention. The spreader system 10 is intended to be positioned within a conventional truck or other vehicle bed (not shown). In this way the spreader system 10 can be transported by the truck to any desired roadway location where any desired material, such as salt or sand, can be distributed by the spreader system 10 onto the road surface. The positioning of the spreader system 10 within the truck and the overall operation of the spreader system 10 in distributing or spreading materials onto a road surface are convention and thus will not be described in detail.

With continuing reference to FIG. 1, the spreader system 10 includes the hopper 12 which is used to hold the material, such as salt or sand, which is to be spread upon the road surface and the conveyor system 30 which transports or conveys the material toward an end of the spreader system 10 where it can be distributed. More specifically, the conveyor system 30 includes a trough 34 (which acts as a frame for the conveyor system 30) and a conveyor chain and/or belt 32 that is operatively connected to and operates within the trough 34. Power means 40 provides power to operate the conveyor chain and/or belt 32. Preferably, the conveyor chain and/or belt 32 transports the material to a spinner system 70 that is attached to one end of the conveyor system 30, as shown, where the material is distributed onto the road surface.

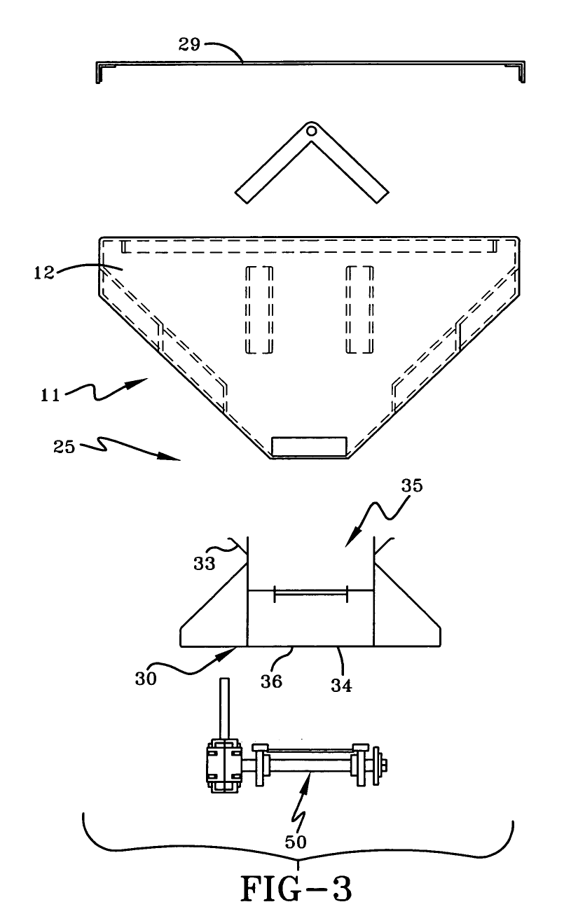

With reference now to FIGS. 1 and 3-6, the preferred hopper assembly 11 will now be described in more detail. As noted above, the inventive hopper is a modular hopper 12. By modular hopper it is meant that with the inventive attaching means 25, the hopper 12 can easily be attached to the trough 34 and also easily detached from the trough 34 for any reason, such as to replace the current hopper 12 with another hopper. This is believed to be a first in the industry. As a result, if the hopper 12 were to become damaged, it could simply be replaced without the need to purchase an entire new spreader system 10. In one embodiment, the attaching means 25 includes a number of bolts or screws that hold the hopper 12 to the top portion 33 (shown in FIG. 3) of the trough 34 after the bottom of the hopper 12 has been positioned within the trough 34.

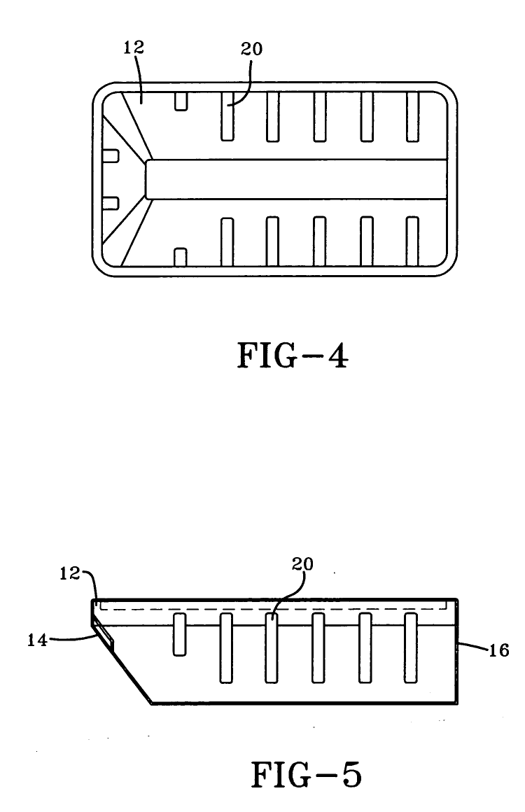

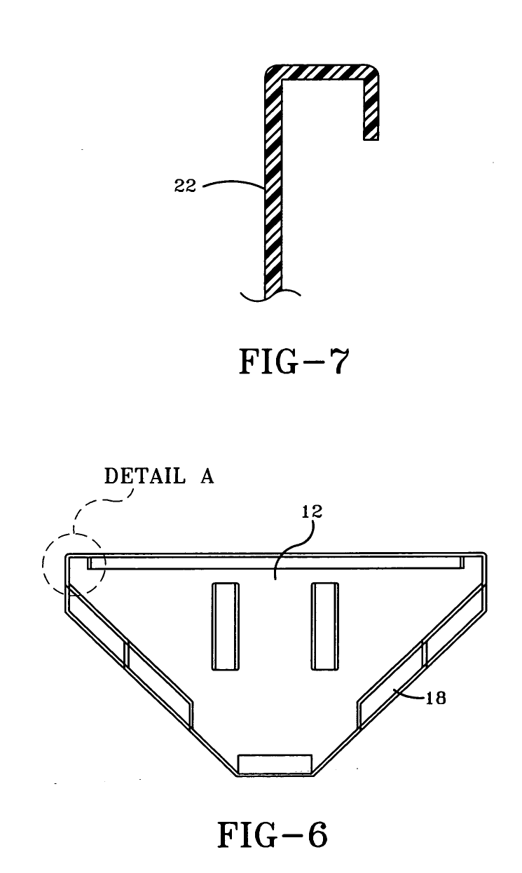

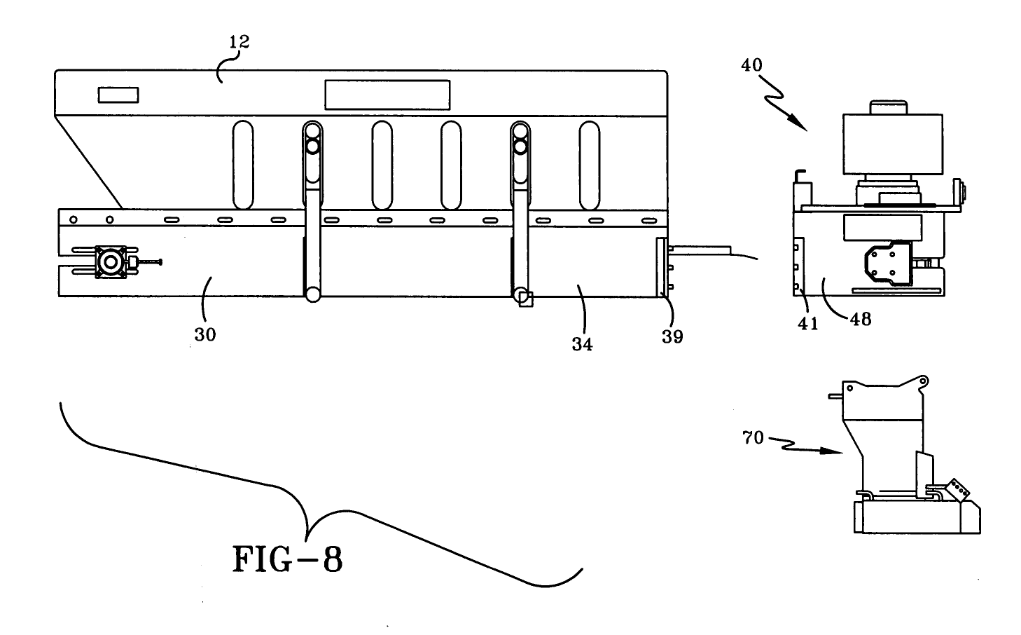

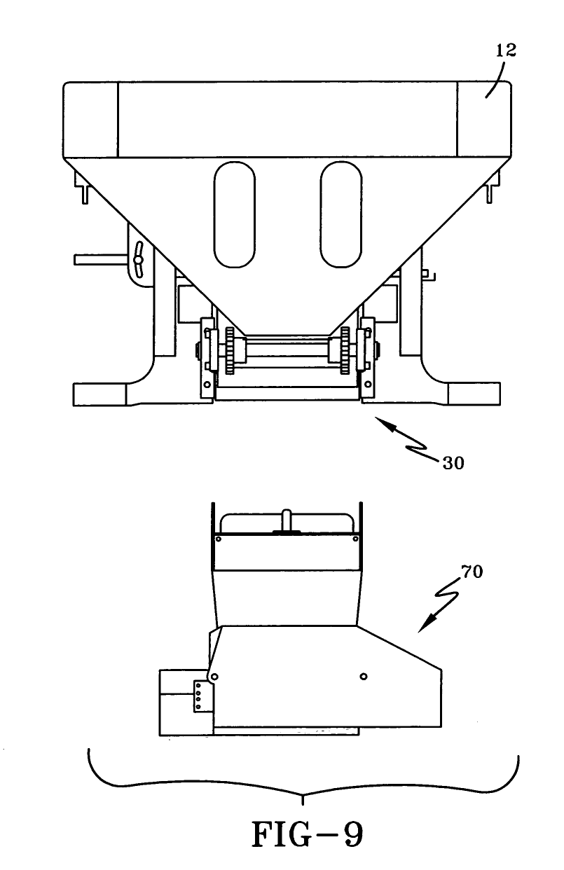

With continuing reference to FIGS. 1 and 3-6, the preferred hopper assembly 11 includes the hopper 12 having a front 14, a back 16, and a pair of sides 18 extending between the front 12 and rear 14, as shown. Preferably the sides 18 are angled, as shown, to form a V-shape as seen best in FIG. 5. The front 14 may be angled as shown to fit within the corresponding truck. The sides 18 and front 14 may have one or more ribs 20, preferably extending in a generally vertical orientation, to increase hopper strength. While the particular size of the hopper 12 can be any chosen with sound engineering judgment, it is preferred to offer a range of hopper sizes between six and ten feet in length. As seen best in FIGS. 6 and 7, preferably the top of the hopper 12 has a lip 22 to increase hopper strength. Preferably the hopper 12 is formed of a plastic material, such as a linear medium density polyethylene. This material is preferable since the hopper may be formed in a rotational molding process. Further, this material is lightweight and corrosion resistant, which is preferable due to the nature of the product it will be carrying and dispensing, namely salt and/or sand. Of course any polymeric material (plastic) may be utilized chosen in accordance with sound engineering judgment.

With reference now to FIGS. 1 and 3, as noted above, the conveyor system 30 includes a trough/frame 34 and a conveyor chain and/or belt 32 that operates within the trough 34. Other well known components of a conveyor system, such as sprockets, are also included with the conveyor system 30. In one embodiment, the trough 34 is formed of any steel chosen with sound engineering judgment. In a preferred embodiment, the trough 34 is formed of a non-corrosive metal, most preferably stainless steel. In another embodiment, all metal parts of the conveyor system 30 are formed of stainless steel. The trough 34 has an open top 35 that receives the hopper 12 as noted above. Optionally, but preferably, a screen 29 is positioned on top of the hopper 12 to prevent foreign material from mixing with the salt or sand in the hopper 12. The screen 29 can be attached to the hopper 12 in any conventional way, such as using bolts to hold the screen 29 to the hopper 12. The trough 34 has a bottom 36 that preferably is closed, as shown. The closed bottom 36 has several advantages. One advantage is that the strength is added to the trough 34. Another advantage is that the conveyor chain and/or belt 32 is substantially enclosed. As a result, the material is prevented from spilling out along the truck bed. Still another advantage of the closed bottom 36 is that abrasion to the truck bed is greatly reduced.

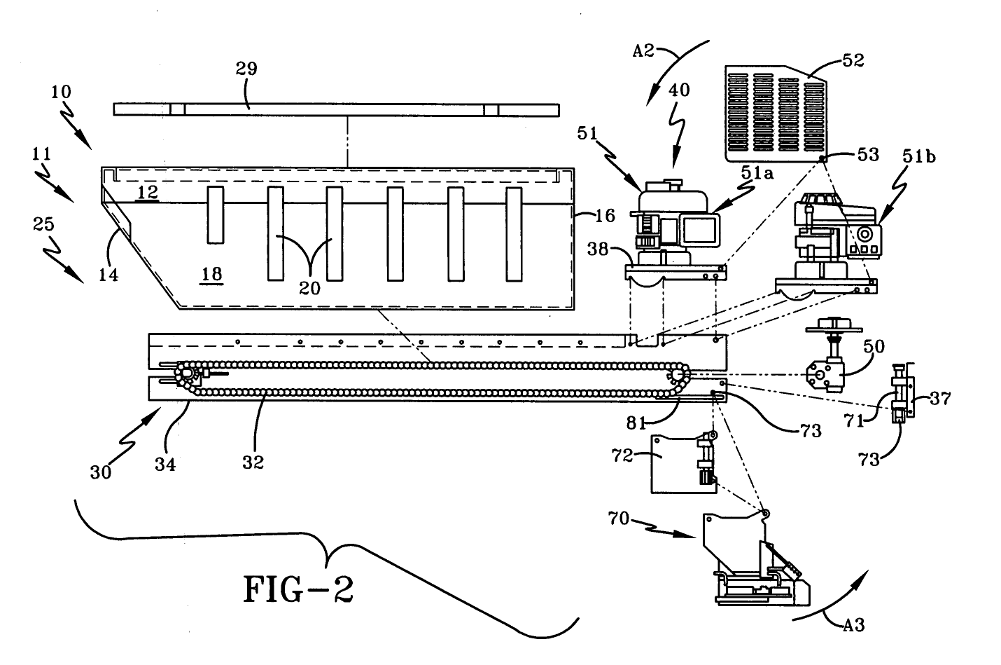

With reference now to FIGS. 1 and 2, the power means 40 provides power to operate the conveyor chain and/or belt 32. In one embodiment, shown in FIG. 1, the power means 40 is a hydraulic unit 42 that operates in a known manner with a conveyor motor 46 to drive the conveyor chain and/or belt 32. In one embodiment, the hydraulic unit 42 is a stand alone unit. In another embodiment, the hydraulic unit 42 is operatively connected to a hydraulic system (not shown) mounted on the vehicle. Preferably the conveyor motor 46 is mounted to a motor mount 48 for installation onto the trough/frame 34, as shown. A cover member 37 may then be attached to the back end of the trough 34, as shown, to protect the conveyor motor 46 and other conveyor components. The hydraulic unit 42 is preferably mounted to a plate 38 which can be easily installed onto the trough 34, as shown. In another embodiment, shown in FIG. 2, the power means 40 uses an internal combustion engine 51 that operates in a known manner with a gearbox 50 to drive the conveyor chain and/or belt 32. Preferably the gearbox 50 is mounted onto the trough/frame 34, as shown. A cover member 37 may then be attached to the back end of the trough 34, as shown, to protect the gearbox 50 and other conveyor components. The engine 51 is preferably mounted to a plate 38 which can be easily installed onto the trough 34, as shown. A shroud 52 may be provided to protect the power means 40, whether the hydraulic unit 42 or the engine 51. Preferably the shroud 52 is pivotably connected to the plate 38 so that it can easily be moved (rotated) to provide accessibility to the power means 40. Most preferably the shroud 52 pivots downward in direction A2 about pivot point 53 from a cover position (where the power means 40 is covered) to an accessible position (where the power means 40 is accessible, uncovered). The pivot point 53 may be a bolt or pivot pin that pivotably connects the shroud 52 to the plate 38. In a preferred embodiment, the motor mount 48, the cover member 37, the plate 38, and the shroud 52 are all constructed from stainless steel or other non-corrosive material to extend the life of the components.

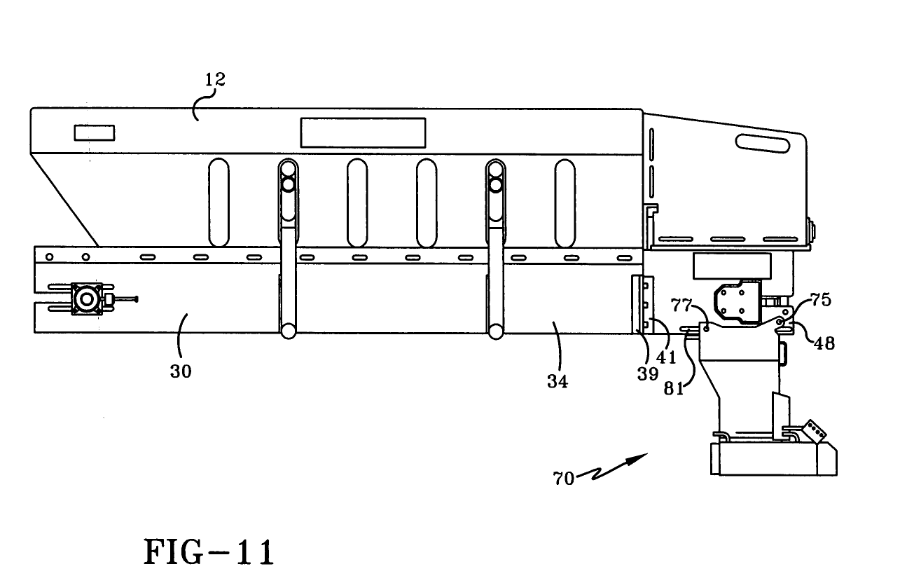

With continuing reference to FIGS. 1 and 2, it should be noted that the preferred power means 40 is modular. By modular it is meant that the power means 40 can easily be attached to the trough 34 and also easily detached from the trough 34 for any reason, such as to replace the current power means 40 with another power means 40. In one embodiment a first engine 51a may be removed from the trough 54 and replaced with a second engine 51b. This may be desirable, for example, when the second engine 51b is a desired upgrade (perhaps more horsepower) from the first engine 51a. In another embodiment, the stand alone hydraulic unit 42 can be replaced with a hydraulic unit that connects to a hydraulic system mounted on the vehicle. The modularity of the power means 40 also extends to replacing the hydraulic unit 42 with the engine 51 or the engine 51 with the hydraulic unit 42. In either case, the corresponding conveyor motor 46 or gearbox 50 may also be replaced. The modularity of the power means 40 is also shown by comparing FIG. 8 (the power means 40 prior to attachment) with FIG. 11 (the power means 40 attached). A first bracket 39 (preferably a section of angle iron) is attached to the trough/frame 34 and a second bracket 41 (also preferably a section of angle iron) is attached to the motor mount 48. To connect the power means 40 to the trough/frame 34, it is only necessary to align the first bracket 39 with the second bracket 41 and then attach, preferably with bolts, the motor mount 48 to the trough/frame 34.

Still referring to FIGS. 1 and 2, the spinner system 70, as is well known, distributes the material from the conveyor system 30 onto the road surface. An optional spinner extension 72 may be utilized to provide a height adjustment for the spinner system 70. Preferably, the spinner may be constructed from a non-corrosive material such as stainless steel. However, any non-corrosive material may be used to construct the spinner and associated components as chosen with sound engineering judgment. The particular operation of the spinner system 70 may be conventional and thus will not be described in detail. Three power embodiments, however, are contemplated. In one embodiment, shown in FIG. 1, the spinner system 70 is powered by the hydraulic unit 42, as shown. In another embodiment, shown in FIG. 2, the spinner system 70 is powered via a drive shaft 71 by the engine 51 using a chain and sprocket system or, alternatively, a belt and pulley system. In a third embodiment, the spinner system 70 and conveyor system 30 is powered with an electric motor. With this embodiment, preferably a chain driven gear box is used to power the conveyor system 30. A separate roller chain may then be connected to a sprocket in the chain driven gear box and connected to the gear box for the spinner shaft. For the embodiments described so far, the spinner system is also controlled by the power means 40. In another embodiment, the spinner system 70 is powered with a separate spinner power means, independent of the hydraulic unit 42, the engine 51 or the electric motor just described. This provides independent control over spinner speed. In a preferred embodiment, the spinner power means is a separate electric motor.

With continuing reference to FIGS. 1 and 2, in a preferred embodiment the spinner system 70 can be easily position adjusted. All known spinner systems remain in their standard operating position. While this position works well for its intended purpose, it creates a problem when it is desirable to remove or dump the remaining material out of the spreader system 10. With known spinner systems, that are stationary, dumping the material requires that all the material must be processed through the spinner system. This can be very time consuming. The preferred spinner system 70 of this invention, however, can be adjusted from its standard operating (down) position, shown, into a dump (up) position. When in the standard operating (down) position, the spinner system 70 operates in a conventional manner. When in the dump (up) position, however, the spinner system 70 is disconnected from the material flow thus making it possible to simply move material along the conveyor chain and/or belt 32 where it drops out of the spreader system 10 (instead of into the spinner system 70).

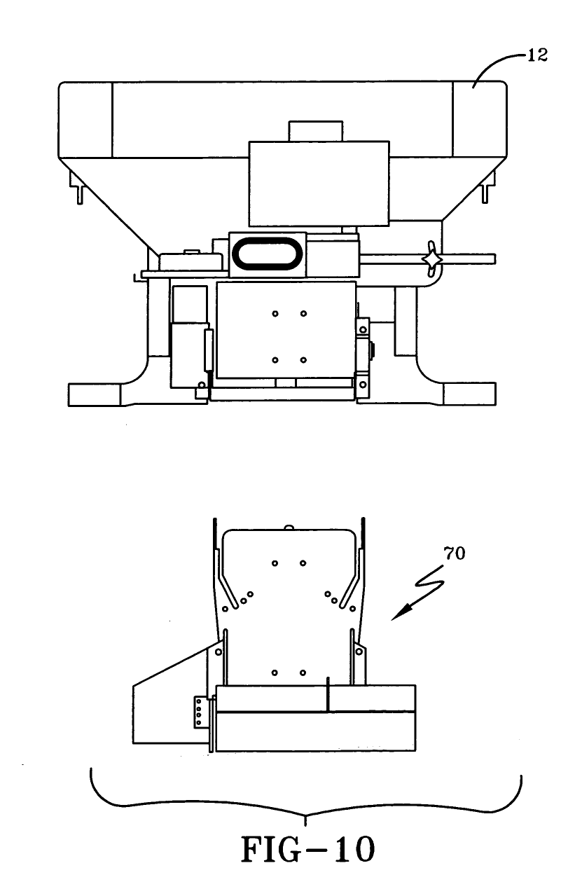

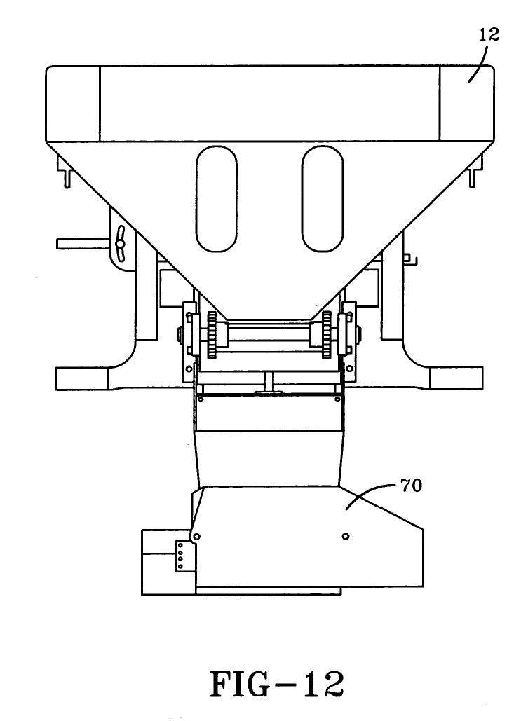

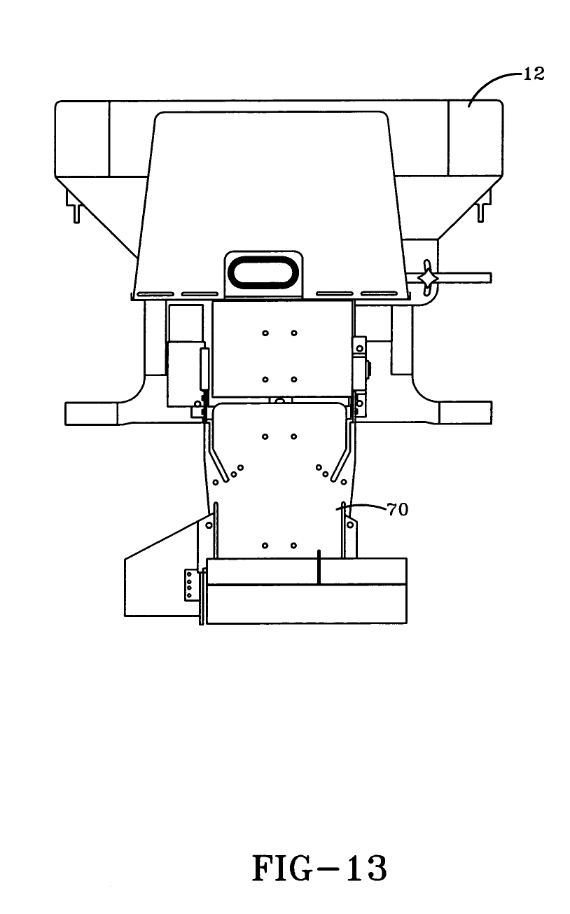

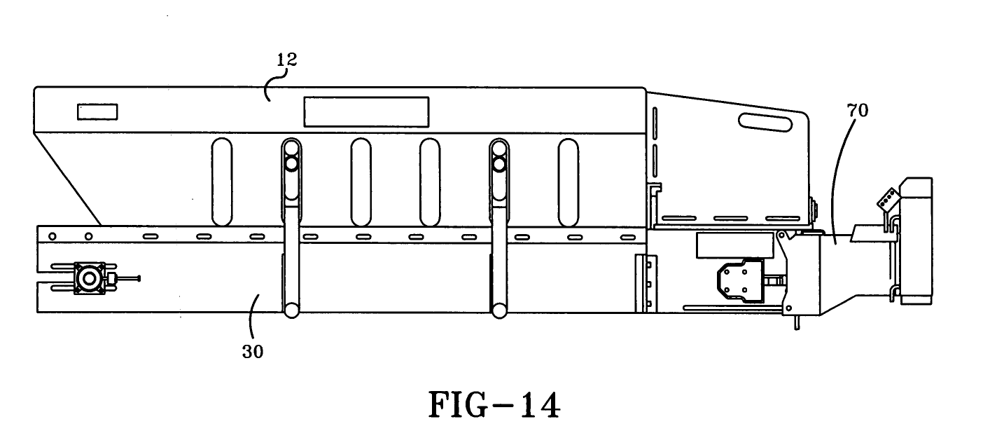

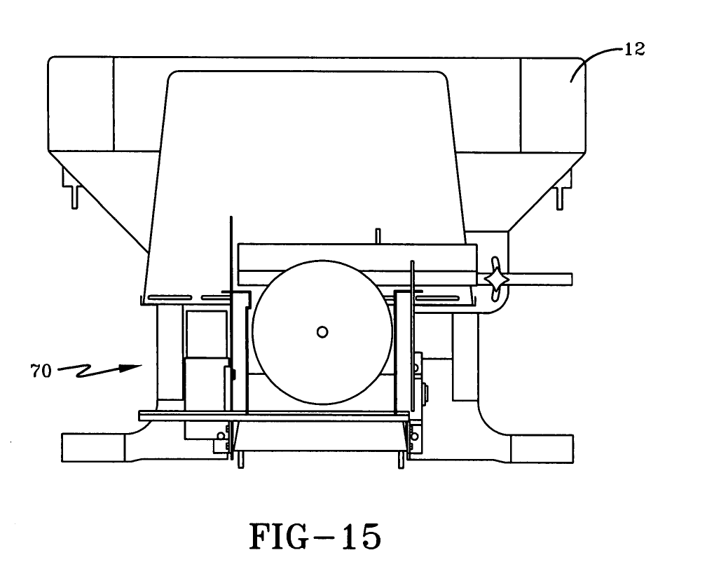

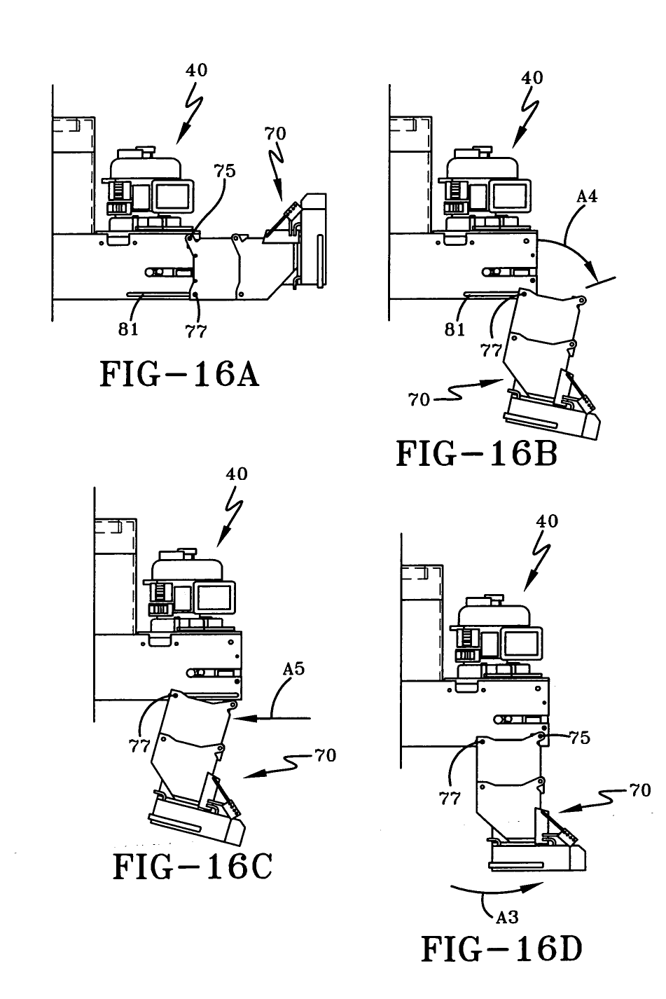

With reference now to FIGS. 1-2 and 8-16, while the particular method for adjusting the spinner system 70 from its standard operating (down) position into a dump (up) position can be any chosen with sound engineering judgment, in a preferred embodiment, the spinner system 70 is pivotably connected to the trough/frame 34. First and second rods 75, 77 extend the width of the spinner system 70 through slots formed in the spinner system 70 and hold the spinner system 70 to the motor mount 48 (FIGS. 11 and 16) or optionally, to the frame/trough 34 (FIGS. 1 and 2). In each case, the basic operation is a follows. To adjust the spinner system 70 from the dump (up) position (FIG. 16A) to the standard operating (down) position (FIG. 16D), the operator first removes the first rod 75. The spinner system 70 is then pivoted about the second rod 77 downward in direction A4 (FIG. 16B). Next, the spinner system 70 is slid in direction A5 (FIG. 16C) with the second rod 77 traveling within slot 81 formed within the frame/trough 34 (or the slot 81 in motor mount 48, FIG. 11). Finally, the spinner system 70 is pivoted, just a little, about the second rod 77 upward in direction A3 (FIG. 16D and FIGS. 1-2) to align the slots and the first rod 75 is inserted to hold or latch the spinner system 70 in place. With reference to FIG. 2, the drive shaft 71 may use a plastic coupling 73. A roll pin may then be received within the plastic coupling 73 when the first rod 75 is inserted. To adjust the spinner system 70 from the standard operating (down) position (FIG. 16D) to the dump (up) position (FIG. 16A), the operator first removes the first rod 75. The spinner system 70 is then slid opposite to direction A5 (FIG. 16C) with the second rod 77 traveling within slot 81. Finally, the spinner system 70 is pivoted about the second rod 77 upward in direction A3 (opposite to direction A4) (FIG. 16D and FIGS. 1-2) to align the slots and the first rod 75 is inserted to hold or latch the spinner system 70 in place.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. A spreader system comprising:
a conveyor system defining a frame;
a hopper; and,
attaching means for selectively attaching the hopper to the frame and for selectively detaching the hopper from the frame.

2. The spreader system of claim 1 wherein the hopper is formed of plastic.

3. The spreader system of claim 2 wherein the hopper is formed of linear medium density polyethylene.

4. The spreader system of claim 3 wherein the hopper is formed in a rotational molding process.

5. The spreader system of claim 1 wherein the frame is formed of stainless steel.

6. The spreader system of claim 1 wherein the conveyor system comprises:
a trough that has a closed bottom.

7. The spreader system of claim 1 wherein the conveyor system comprises:
power means for powering a conveyor, the power means comprising a hydraulic unit.

8. The spreader system of claim 1 wherein the conveyor system comprises:
power means for powering a conveyor, the power means comprising an internal combustion engine.

9. The spreader system of claim 1 wherein the conveyor system comprises:
power means for powering a conveyor; and,
a shroud that selectively covers the power means, the shroud is selectively pivotable in a downward direction to provide access to the power means.

10. The spreader system of claim 1 further comprising:
a spinner system that is selectively adjustable from a standard operating position to a dump position.

11. The spreader system of claim 10 further comprising:
power means for powering a conveyor; and,
spinner power means for powering the spinner system, the spinner power means providing control of the spinner system independent of the power means.

12. A method comprising the steps of:
providing a vehicle;
providing a spreader system operatively connected to the vehicle, the spreader system comprising a frame, a conveyor system operatively connected to the frame, and a first hopper operatively connected to the frame;
removing the first hopper from the frame; and,
mounting a second hopper to the frame.

13. The method of claim 12 further comprising the steps of:
forming the first hopper of plastic; and,
forming the second hopper of plastic.

14. A method comprising the steps of:
providing a spreader system comprising a frame, a conveyor system operatively connected to the frame, and a first hopper operatively connected to the frame;
providing a spinner system attached to the frame;
pivoting the spinner system from a dump (up) position to a standard operating (down) position.

15. The method of claim 14 wherein the step of pivoting the spinner system from a dump (up) position to a standard operating (down) position comprises the steps of:
removing a first rod that holds the spinner system in the dump (up) positon;
pivoting the spinner system about a second rod;
reinserting the first rod to hold the spinner system in the standard operating (down) position.

16. The method of claim 15 wherein prior to the step of reinserting the first rod to hold the spinner system in the standard operating (down) position, the method comprises the step of:
sliding the spinner system and second rod within a slot.
